(19) United States
(12) Patent Application Publication
(10) Pub. No.: US 2023/0057858 A1
(43) Pub. Date: Feb. 23, 2023

(54) Handling Variable Payload Lengths Which Are Based On Different AMR Audio Codec Rates

(71) Applicant: Parallel Wireless, Inc., Nashua, NH (US)

(72) Inventor: Venumadhav Josyula, Pune (IN)

(21) Appl. No.: 17/526,275

(22) Filed: Nov. 15, 2021

Related U.S. Application Data
(60) Provisional application No. 63/110,402, filed on Nov. 6, 2020.

(51) Int. Cl. G10L 19/02

(52) U.S. Cl. CPC G10L 19/02; G10L 2019/0004

(57) ABSTRACT

Systems, methods and computer software are disclosed for handling variable payload lengths which are based on different Adaptive Multi-Rate (AMR) audio codecs. In one embodiment, the method includes sending a message during flow establishment giving an Active Codec Set (ACS) and a codec type by sending a message; preparing a map where each bit of the map indicates a Frame Type (FT) during establishment of the flow; extracting the FT from the received packet in the received Adaptive Multi-Rate (AMR) header; using the extracted FT, checking if the rate is supported and if supported, obtaining a payload length for that rate from a table; and once an AMR payload length is known performing further processing.

### CROSS-REFERENCE TO RELATED APPLICATIONS

This application claims priority under 35 U.S.C. § 119(e) to U.S. Provisional Pat. App. No. 63/110,402, filed Nov. 6, 2020, titled “Handling Variable Payload Lengths Which Are Based On Different AMR Audio Codec Rates” which is hereby incorporated by reference in its entirety for all purposes. This application also hereby incorporates by reference, for all purposes, each of the following U.S. Pat. App. Pub. Nos. US20110044285, US20140241316; WO Pat. App. Pub. No. WO2013145592A1; EP Pat. App. Pub. No. EP2773151A1; U.S. Pat. No. 8,879,416, “Heterogeneous Mesh Network and Multi-RAT Node Used Therein,” filed May 8, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/777,246, “Methods of Enabling Base Station Functionality in a User Equipment,” filed Sep. 15, 2016; U.S. patent application Ser. No. 14/289,821, “Method of Connecting Security Gateway to Mesh Network,” filed May 29, 2014; U.S. patent application Ser. No. 14/642,544, “Federated X2 Gateway,” filed Mar. 9, 2015; U.S. patent application Ser. No. 14/711,293, “Multi-Egress Backhaul,” filed May 13, 2015; U.S. Pat. App. No. 62/375,341, “S2 Proxy for Multi-Architecture Virtualization,” filed Aug. 15, 2016; U.S. patent application Ser. No. 15/132,229, “MaxMesh: Mesh Backhaul Routing,” filed Apr. 18, 2016, each in its entirety for all purposes, having attorney docket numbers PWS-71700US01, 71710US01, 71717US01, 71721US01, 71756US01, 71762US01, 71819US00, and 71820US01, respectively. This application also hereby incorporates by reference in their entirety each of the following U.S. Pat. applications or Pat. App. Publications: US20150098387A1 (PWS-71731US01); US20170055186A1 (PWS-71815U501); US20170273134A1 (PWS-71850U501); US20170272330A1 (PWS-71850US02); and Ser. No. 15/713,584 (PWS-71850US03). This application also hereby incorporates by reference in their entirety U.S. patent application Ser. No. 16/424,479, “5G Interoperability Architecture,” filed May 28, 2019; and U.S. Provisional Pat. Application No. 62/804,209, “5G Native Architecture,” filed Feb. 11, 2019.

### BACKGROUND

The relevant 3GPP Specs are TS26.101 for Composition of AMR Frames for all Frame Types, and the relevant for RFC 4867 for AMR codec header, in which we are interested in the bandwidth efficient mode (Sections 4.2, 4,3, 4,3,1, 4,3,2). TS 28.062 for the preferred codec list.

Fastpath is a mechanism for processing packet transfer at high speed. Fastpath is an alternative routing mechanism to the routing table. In fast path, the responses to incoming network traffic are sent back by using the same interface as the incoming traffic. By avoiding the routing table lookup, fast path provides a quick access to data.

If fastpath is enabled on an interface group and a physical interface in that group receives an incoming request, the same physical interface might not send a response to the request. Instead, any other physical interface in an interface group can send the response.

### SUMMARY

A method, system and computer readable medium are described for handling variable payload lengths which are based on different AMR audio codec rates. In one embodiment, a method includes sending a message during flow establishment giving an Active Codec Set (ACS) and a codec type by sending a message; preparing a map where each bit of the map indicates a Frame Type (FT) during establishment of the flow; extracting the FT from the received packet in the received Adaptive Multi-Rate (AMR) header; using the extracted FT, checking if the rate is supported and if supported, obtaining a payload length for that rate from a table; and once an AMR payload length is known, performing further processing.

In another embodiment a system for handling variable payload lengths which are based on different Adaptive Multi-Rate (AMR) audio codecs includes a base transceiver station (BTS); a HetNet Gateway (HNG) in communication with the BTS; a Mobile GateWay (MGW) in communication with the HNG; wherein first packet data is sent between the BTS and the HNG; and wherein second packet data is sent between the HNG and the MGW. Fastpath (operating at the HNG) may be used for receiving an active code set and a message, after which the map where each bit of the map indicates a Frame Type (FT) is prepared, and wherein further processing takes place once the AMR payload length is known in the Fastpath.

In another embodiment a non-transitory computer-readable medium containing instructions for handling variable payload lengths which are based on different Adaptive Multi-Rate (AMR) audio codecs which, when executed, cause a system to perform steps including sending a message during flow establishment giving an Active Codec Set (ACS) to Fastpath and a codec type by sending a message; preparing, once Fastpath receives the message, a map where each bit of the map indicates a Frame Type (FT) during establishment of the flow; extracting the FT from the received packet in the received Adaptive Multi-Rate (AMR) header; using the extracted FT, checking if the rate is supported and if supported, obtaining a payload length for that rate from a table; and once an AMR payload length is known in the Fastpath, performing further processing.

### BRIEF DESCRIPTION OF THE DRAWINGS

FIG. 1 is a table showing frame type. Mode indication and mode request fields, in accordance with some embodiments.

FIG. 2 is a table showing number of bits in classes for each AMR code, in accordance with some embodiments.

FIGS. 3A and 3B are a tables showing the FT for each rate, in accordance with some embodiments.

FIG. 4 is an architecture diagram, in accordance with some embodiments.

FIG. 5 is a schematic network architecture diagram for 3G and other-G prior art networks.

FIG. 6 is an enhanced eNodeB for performing the methods described herein, in accordance with some embodiments.

FIG. 7 is a coordinating server for providing services and performing methods as described herein, in accordance with some embodiments.

### DETAILED DESCRIPTION

In bandwidth efficient mode,

AMR codec header

Payload header

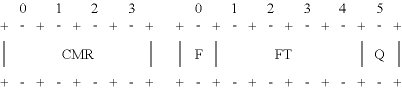

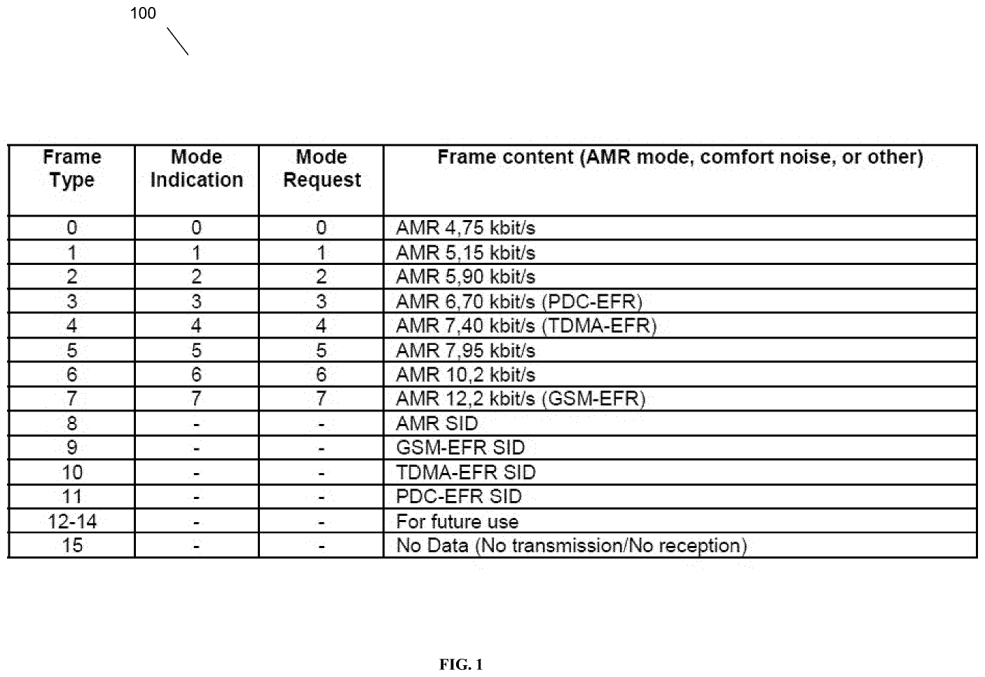

The “FT” is defined in FIG. 1

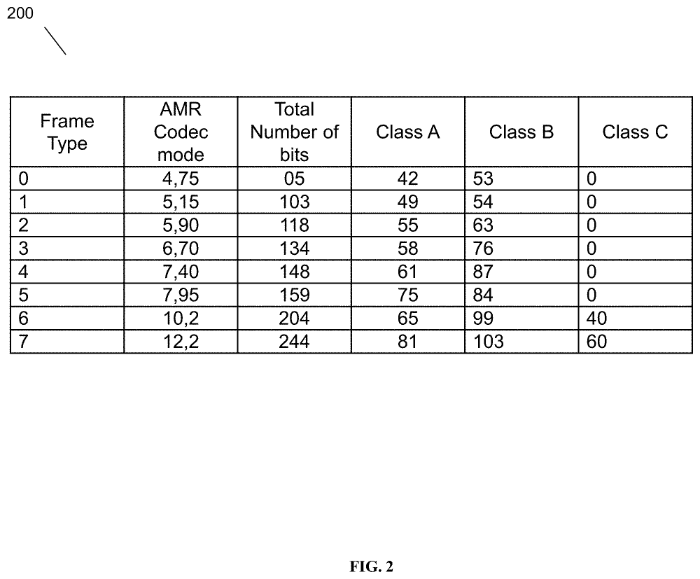

Now for each rate, FIG. 2 represents how many bits to be used.

Now Fastpath (operating as part of the HNG) is interested in “Total number of bits” column in the table of FIG. 2 which would be rounded to nearest byte during the implementation.

For 2G AMR, packet lengths can be variable. The AMR payload packet length is dependent on the ACS (Active Codec set, which tells us about the different rate(s) supported), now depending the ACS value, the AMR payload packet length can vary. Now in Fastpath it does not know the AMR payload length. So, it needs to peek and extract FT to understand the length. Now there is a mechanism required to derive the payload length when the FT has different values. This is applicable for both AMR-FR, AMR-HR as well. All these are spec driven. Now when the packet is received, in the AMR header has something called FT (Frame type). Now there is a table in the spec where each frame type index is mapped to certain rate.

During the flow establishment by application, fastpath is given the ACS, and codec type (HR or FR) by sending a message.

Once Fastpath receives that messages, it prepares a “rate_to_frametype_map” (where each bit indicates FT) during the establishment of the flow. Each bit is fit is set based on the following table

Now FT for each rate is based on FIG. 2.

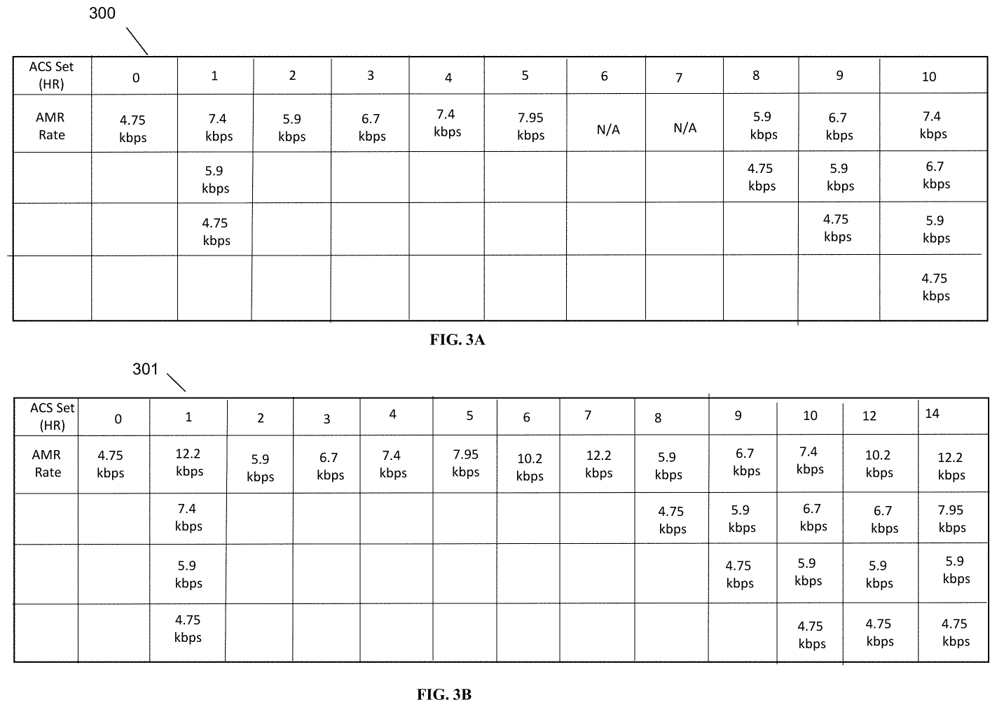

There is another table 300 shown in FIG. 3A, referred to as “rate_to_frametype_payloadlength” which is static table indexed by “FT” which has different payload lengths.

During the packet processing, the FT is extracted from the received packet in the received AMR header. With extracted FT following actions are taken in fastpath,

Fastpath will check if the rate is supported.

If supported, we will get the payload length for that rate from the “rate_to_frametype_payloadlength” table.

Once AMR payload length is known in the Fastpath will do further processing.

While the example used for explanation purposes recites the use of Fastpath at the HNG, it should be appreciated that the routing table could also be used.

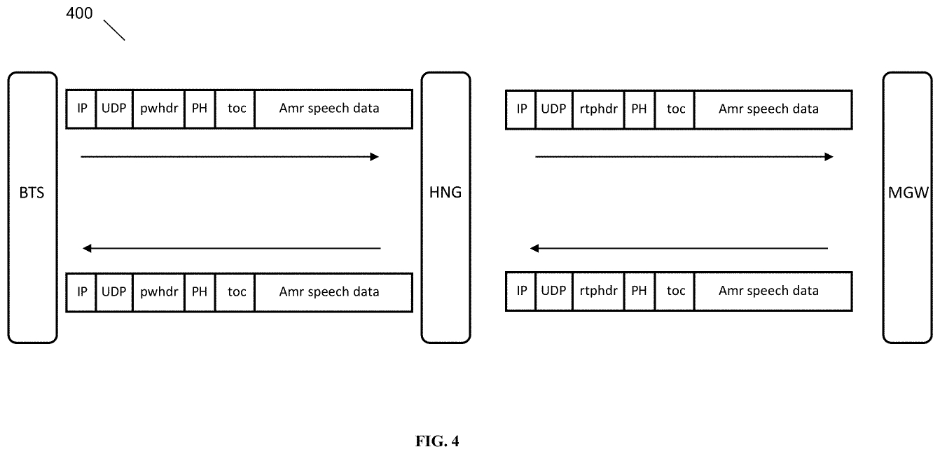

An architecture diagram is shown in FIG. 4

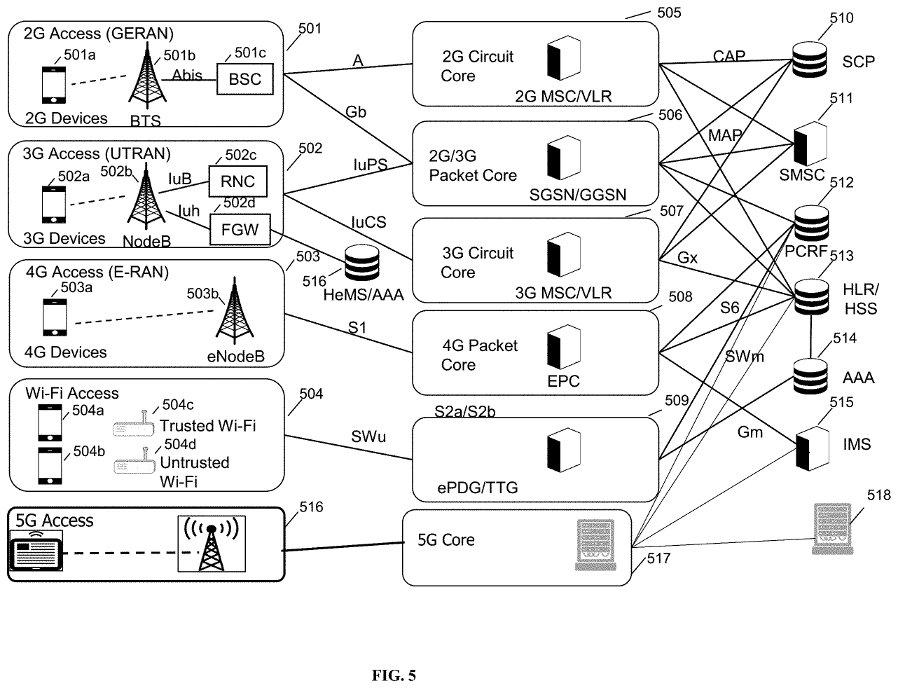

FIG. 5 is a schematic network architecture diagram for 3G and other-G prior art networks. The diagram shows a plurality of “Gs,” including 2G, 3G, 4G, 5G and Wi-Fi. 2G is represented by GERAN 401, which includes a 2G device 501a, BTS 501b, and BSC 501c. 3G is represented by UTRAN 502, which includes a 3G UE 502a, nodeB 502b, RNC 502c, and femto gateway (FGW, which in 3GPP namespace is also known as a Home nodeB Gateway or HNBGW) 502d. 4G is represented by EUTRAN or E-RAN 503, which includes an LTE UE 503a and LTE eNodeB 503b. Wi-Fi is represented by Wi-Fi access network 504, which includes a trusted Wi-Fi access point 504c and an untrusted Wi-Fi access point 504d. The Wi-Fi devices 504a and 504b access either AP 504c or 504d. In the current network architecture, each “G” has a core network. 2G circuit core network 505 includes a 2G MSC/VLR; 2G/3G packet core network 506 includes an SGSN/GGSN (for EDGE or UMTS packet traffic); 3G circuit core 507 includes a 3G MSC/VLR; 5G circuit core 508 includes an evolved packet core (EPC); and in some embodiments the Wi-Fi access network is connected via an ePDG/TTG using S2a/S2b. Each of these nodes are connected via a number of different protocols and interfaces, as shown, to other, non-“G”-specific network nodes, such as the SCP 530, the SMSC 531, PCRF 532, HLR/HSS 533, Authentication, Authorization, and Accounting server (AAA) 534, and IP Multimedia Subsystem (IMS) 535. An HeMS/AAA 536 is present in some cases for use by the 3G UTRAN. The diagram is used to indicate schematically the basic functions of each network as known to one of skill in the art, and is not intended to be exhaustive. For example, 5G core 517 is shown using a single interface to 5G access 516, although in some cases 5G access can be supported using dual connectivity or via a non-standalone deployment architecture.

Noteworthy is that the RANs 501, 502, 503, 504 and 536 rely on specialized core networks 505, 506, 507, 508, 509, 537 but share essential management databases 530, 531, 532, 533, 534, 535, 538. More specifically, for the 2G GERAN, a BSC 501c is required for Abis compatibility with BTS 501b, while for the 3G UTRAN, an RNC 502c is required for Iub compatibility and an FGW 502d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

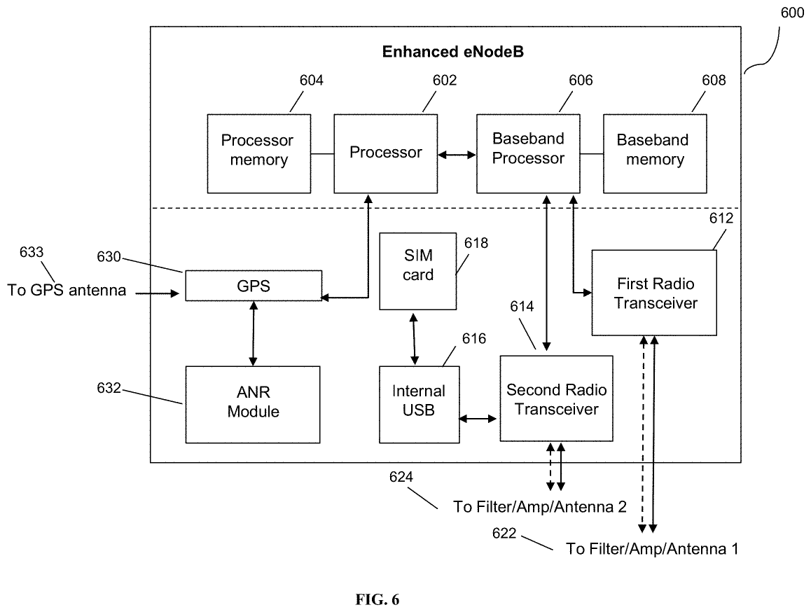

FIG. 6 is an enhanced eNodeB for performing the methods described herein, in accordance with some embodiments. Mesh network node 600 includes processor 602, processor memory 604 in communication with the processor, baseband processor 606, and baseband processor memory 608 in communication with the baseband processor. Mesh network node 600 also includes first radio transceiver 612 and second radio transceiver 614, internal universal serial bus (USB) port 616, and subscriber information module card (SIM card) 618 coupled to USB port 616. In some embodiments, the second radio transceiver 614 itself is coupled to USB port 616, and communications from the baseband processor is passed through USB port 616. The second radio transceiver is used for wirelessly backhauling eNodeB 600.

Processor 602 and baseband processor 606 are in communication with one another. Processor 602 performs routing functions, and determines if/when a switch in network configuration is needed. Baseband processor 606 generates and receives radio signals for both radio transceivers 612 and 614, based on instructions from processor 602. In some embodiments, processors 602 and 606 are on the same physical logic board. In other embodiments, they are on separate logic boards.

Processor 602 identifies the appropriate network configuration, and performs routing of packets from one network interface to another accordingly. Processor 602 uses memory 604, in particular to store a routing table to be used for routing packets. Baseband processor 606 performs operations to generate the radio frequency signals for transmission or retransmission by both transceivers 610 and 612. Baseband processor 606 also performs operations to decode signals received by transceivers 612 and 614. Baseband processor 606 uses memory 608 to perform these tasks.

The first radio transceiver 612 is a radio transceiver capable of providing LTE eNodeB functionality, and is capable of higher power and multi-channel OFDMA. The second radio transceiver 614 is a radio transceiver capable of providing LTE UE functionality. Both transceivers 612 and 614 are capable of receiving and transmitting on one or more LTE bands. In some embodiments, either or both of transceivers 612 and 614 are capable of providing both LTE eNodeB and LTE UE functionality. Transceiver 612 is coupled to processor 602 via a Peripheral Component Interconnect-Express (PCI-E) bus, and/or via a daughtercard. As transceiver 614 is for providing LTE UE functionality, in effect emulating a user equipment, it is also connected via the same or different PCI-E bus, or by a USB bus, and is also be coupled to SIM card 618. First transceiver 612 is coupled to first radio frequency (RF) chain (filter, amplifier, antenna) 622, and second transceiver 614 is coupled to second RF chain (filter, amplifier, antenna) 624.

SIM card 618 provides information required for authenticating the simulated UE to the evolved packet core (EPC). When no access to an operator EPC is available, a local EPC is used, or another local EPC on the network is used. This information is stored within the SIM card, and includes one or more of an international mobile equipment identity (IMEI), international mobile subscriber identity (IMSI), or other parameter needed to identify a UE. Special parameters are stored in the SIM card or provided by the processor during processing to identify to a target eNodeB that device 600 is not an ordinary UE but instead is a special UE for providing backhaul to device 600.

Wired backhaul or wireless backhaul is used. Wired backhaul is an Ethernet-based backhaul (including Gigabit Ethernet), or a fiber-optic backhaul connection, or a cable-based backhaul connection, in some embodiments. Additionally, wireless backhaul is provided in addition to wireless transceivers 612 and 614, which is Wi-Fi 802.11a/b/g/n/ac/ad/ah, Bluetooth, ZigBee, microwave (including line-of-sight microwave), or another wireless backhaul connection. Any of the wired and wireless connections described herein is used flexibly for either access (providing a network connection to UEs) or backhaul (providing a mesh link or providing a link to a gateway or core network), according to identified network conditions and needs, and is under the control of processor 602 for reconfiguration.

A GPS module 630 is also be included, and is in communication with a GPS antenna 632 for providing GPS coordinates, as described herein. When mounted in a vehicle, the GPS antenna is located on the exterior of the vehicle pointing upward, for receiving signals from overhead without being blocked by the bulk of the vehicle or the skin of the vehicle. Automatic neighbor relations (ANR) module 632 is present and is run on processor 602 or on another processor, or is located within another device, according to the methods and procedures described herein.

Other elements and/or modules are also included, such as a home eNodeB, a local gateway (LGW), a self-organizing network (SON) module, or another module. Additional radio amplifiers, radio transceivers and/or wired network connections are included.

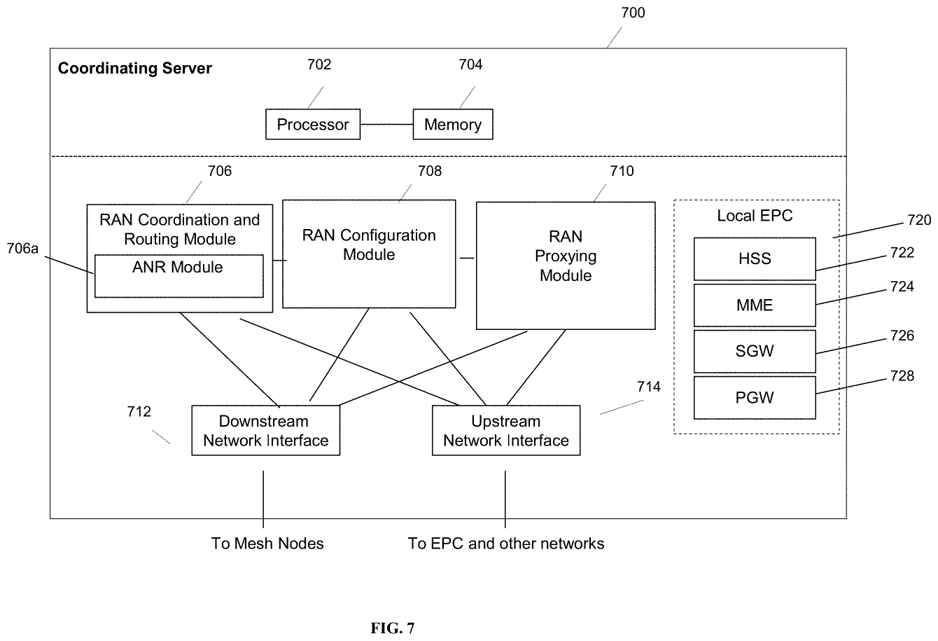

FIG. 7 is a coordinating server for providing services and performing methods as described herein, in accordance with some embodiments. Coordinating server 700 includes processor 702 and memory 704, which are configured to provide the functions described herein. Also present are radio access network coordination/routing (RAN Coordination and routing) module 706, including ANR module 706a, RAN configuration module 708, and RAN proxying module 710. The ANR module 706a performs the ANR tracking, PCI disambiguation, ECGI requesting, and GPS coalescing and tracking as described herein, in coordination with RAN coordination module 706 (e.g., for requesting ECGIs, etc.). In some embodiments, coordinating server 700 coordinates multiple RANs using coordination module 706. In some embodiments, coordination server also provides proxying, routing virtualization and RAN virtualization, via modules 710 and 708. In some embodiments, a downstream network interface 712 is provided for interfacing with the RANs, which is a radio interface (e.g., LTE), and an upstream network interface 714 is provided for interfacing with the core network, which is either a radio interface (e.g., LTE) or a wired interface (e.g., Ethernet).

Coordinator 700 includes local evolved packet core (EPC) module 720, for authenticating users, storing and caching priority profile information, and performing other EPC-dependent functions when no backhaul link is available. Local EPC 720 includes local HSS 722, local MME 724, local SGW 726, and local PGW 728, as well as other modules. Local EPC 720 incorporates these modules as software modules, processes, or containers. Local EPC 720 alternatively incorporates these modules as a small number of monolithic software processes. Modules 706, 708, 710 and local EPC 720 each run on processor 702 or on another processor, or is located within another device.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof, including 5G, which supports VoLTE.

The word “cell” is used herein to denote either the coverage area of any base station, or the base station itself, as appropriate and as would be understood by one having skill in the art. For purposes of the present disclosure, while actual PCIs and ECGIs have values that reflect the public land mobile networks (PLMNs) that the base stations are part of, the values are illustrative and do not reflect any PLMNs nor the actual structure of PCI and ECGI values.

In the above disclosure, it is noted that the terms PCI conflict, PCI confusion, and PCI ambiguity are used to refer to the same or similar concepts and situations, and should be understood to refer to substantially the same situation, in some embodiments. In the above disclosure, it is noted that PCI confusion detection refers to a concept separate from PCI disambiguation, and should be read separately in relation to some embodiments. Power level, as referred to above, refers to RSSI, RSFP, or any other signal strength indication or parameter.

In some embodiments, the software needed for implementing the methods and procedures described herein are implemented in a high level procedural or an object-oriented language such as C, C++, C#, Python, Java, or Perl. The software is in assembly language if desired. Packet processing implemented in a network device can include any processing determined by the context. For example, packet processing involves high-level data link control (HDLC) framing, header compression, and/or encryption. In some embodiments, software that, when executed, causes a device to perform the methods described herein are stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein are base stations compatible with a Long Term Evolution (LTE) radio transmission protocol or air interface. The LTE-compatible base stations are eNodeBs. In addition to supporting the LTE protocol, the base stations also support other air interfaces, such as UMTS/HSPA, CDMA/CDMA2000, GSM/EDGE, GPRS, EVDO, other 3G/2G, 5G, legacy TDD, or other air interfaces used for mobile telephony. 5G core networks that are standalone or non-standalone have been considered by the inventors as supported by the present disclosure.

In some embodiments, the base stations described herein support Wi-Fi air interfaces, which also include one or more of IEEE 802.11a/b/g/n/ac/af/p/h. In some embodiments, the base stations described herein support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols including 5G, or other air interfaces.

The foregoing discussion discloses and describes merely exemplary embodiments of the present invention. In some embodiments, software that, when executed, causes a device to perform the methods described herein are stored on a computer-readable medium such as a computer memory storage device, a hard disk, a flash drive, an optical disc, or the like. As will be understood by those skilled in the art, the present invention is embodied in other specific forms without departing from the spirit or essential characteristics thereof. For example, wireless network topology can also apply to wired networks, optical networks, and the like. The methods apply to LTE-compatible networks, to UMTS-compatible networks, to 5G networks, or to networks for additional protocols that utilize radio frequency data transmission. Various components in the devices described herein are added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure are made without departing from the spirit and scope of the disclosure, which is limited only by the claims which follow. Various components in the devices described herein are added, removed, or substituted with those having the same or similar functionality. Various steps as described in the figures and specification are added or removed from the processes described herein, and the steps described are performed in an alternative order, consistent with the spirit of the invention. Features of one embodiment are used in another embodiment. Other embodiments are within the following claims.

1. A method for handling variable payload lengths which are based on different Adaptive Multi-Rate (AMR) audio codecs, comprising:
sending a message during flow establishment giving an Active Codec Set (ACS) and a codec type by sending a message;
preparing a map where each bit of the map indicates a Frame Type (FT) during establishment of the flow;
extracting the FT from the received packet in the received Adaptive Multi-Rate (AMR) header;
using the extracted FT, checking if the rate is supported and if supported, obtaining a payload length for that rate from a table; and
once an AMR payload length is known, performing further processing.

2. The method of claim 1 wherein a codec type is a Half Rate (HR) channel type or a Full Rate (FR) channel type.

3. The method of claim 1 wherein preparing a map comprises preparing a rate_to_frametype_map.

4. The method of claim 1 wherein obtaining a payload length for that rate from a table comprises obtaining a payload length for that rate from a rate_to_frametype_payloadlength table.

5. The method of claim 4 wherein obtaining a payload length for that rate from a rate_to_frametype_payloadlength table comprises obtaining a payload length for that rate from a rate_to_frametype_payloadlength table that comprises a static table indexed by the FT and which has different payload lengths.

6. The method of claim 1 wherein performing further processing comprises checking if the rate is supported.

7. A system for handling variable payload lengths which are based on different Adaptive Multi-Rate (AMR) audio codecs, comprising:
a base transceiver station (BTS);
a HetNet Gateway (HNG) in communication with the BTS;
a Mobile GateWay (MGW) in communication with the HNG;
wherein first packet data is sent between the BTS and the HNG; and
wherein second packet data is sent between the HNG and the MGW.

8. The system of claim 7 wherein the first packet data includes Internet Protocol (IP) data, User Datagram Protocol (UDP) data, PWHND data, PH data, TOC Data, and ANMR speech data.

9. The system of claim 7 wherein the second packet data includes IP data, UDP data, RTPHDR data, PH data, TOC Data, and ANMR speech data.

10. The system of claim 7 wherein a message is sent during flow establishment giving an Active Codec Set (ACS) and a codec type by sending a message;
a map is prepared where each bit of the map indicates a Frame Type (FT) during establishment of the flow;
the FT is extracted from the received packet in the received Adaptive Multi-Rate (AMR) header;
the extracted FT is used to check if the rate is supported and if supported, a payload length for that rate from a table is obtained; and
once an AMR payload length is known, further processing is performed.

11. The system of claim 10 wherein a codec type is a Half Rate (HR) channel type or a Full Rate (FR) channel type.

12. The system of claim 7 wherein the map comprises a rate_to_frametype_map.

13. The system of claim 7 wherein the table comprises a rate_to_frametype_payloadlength table.

14. The system of claim 13 wherein the rate_to_frametype_payloadlength table comprises a static table indexed by the FT and which has different payload lengths.

15. A non-transitory computer-readable medium containing instructions for handling variable payload lengths which are based on different Adaptive Multi-Rate (AMR) audio codecs which, when executed, cause a system to perform steps comprising:
sending a message during flow establishment giving an Active Codec Set (ACS) and a codec type by sending a message;
preparing a map where each bit of the map indicates a Frame Type (FT) during establishment of the flow;
extracting the FT from the received packet in the received Adaptive Multi-Rate (AMR) header;
using the extracted FT, checking if the rate is supported and if supported, obtaining a payload length for that rate from a table; and
once an AMR payload length is known in the Fastpath, performing further processing.

16. The computer-readable medium of claim 15 further comprising instructions wherein a codec type is a Half Rate (HR) channel type or a Full Rate (FR) channel type.

17. The computer-readable medium of claim 15 further comprising instructions for preparing a map comprises preparing a rate_to_frametype_map.

18. The computer-readable medium of claim 15 wherein instructions for obtaining a payload length for that rate from a table comprises instructions for obtaining a payload length for that rate from a rate_to_frametype_payloadlength table.

19. The computer-readable medium of claim 18 wherein instructions for obtaining a payload length for that rate from a rate_to_frametype_payloadlength table comprises instructions for obtaining a payload length for that rate from a rate_to_frametype_payloadlength table that comprises a static table indexed by the FT and which has different payload lengths.

20. The computer-readable medium of claim 1 wherein instructions for performing further processing comprise instructions for checking if the rate is supported.
